(19) United States
(12) Patent Application Publication
(10) Pub. No.: US 2006/0242653 A1
(43) Pub. Date: Oct. 26, 2006

(54) Request-response handling system for web-based applications

(75) Inventor: Michael Kostadinovich, New York, NY (US)

Correspondence Address: ZITO TLP, 26005 RIDGE ROAD, SUITE 203, DAMASCUS, MD, 20872, US

(73) Assignee: Anthony V. Pugliese III

(21) Appl. No.: 11/249,229

(22) Filed: Oct. 13, 2005

Related U.S. Application Data
(60) Provisional application No. 60/673,279, filed on Apr. 20, 2005.

(51) Int. Cl. G06F 9/46; G06F 9/44

(52) U.S. Cl. 719/330; 719/328

(57) ABSTRACT

A high-level system for developing web-based applications which when completed provide a common set of request and response handling processes to support multiple sets of business logic tools. An abstraction layer within the request-response framework permits the development of separate, application-appending tools which address only their core business logic-related functions, leaving the request and response handling functions to the adaptive processes of the common administrative framework. The system also supports concurrent usage by multiple user-agent/client types. Integration details for all desired user types are provided via plugins developed during the application's creation.

### RELATED APPLICATIONS

This application claims the benefit of U.S. Provisional Application No. 60/673,279 filed Apr. 2, 2005.

### FIELD OF THE INVENTION

The present invention relates to the field of web applications. More specifically, the present invention is a web applications system for developing user-independent web applications supporting multiple business tool implementations.

### BACKGROUND OF THE INVENTION

Web application frameworks are a developing area of extending Internet use. Several application development concepts have emerged in recent years, each typically centered around a unique development language for implementation of the concept. For example, JSP, Pearl CGI, PHP and .Net/ASP are all examples of common languages used in the design of web applications. These languages are commonly extended by application designers to the creation of application development kits, which facilitates the creation of web applications by web application designers.

Web applications typically involve using business logic to provide useful services to users of the site. Selecting a book to purchase and adding it to a shopping cart is a familiar example of business logic.

Despite the disparate development concepts, nearly every web application develops through a process of determining the desired set of business logic needed, and developing the application around that logic. This process typically involves integrating the business logic with request and response oriented administrative functions. For example, business logic designed to allow a user of a website to purchase a book would need to be augmented on the request-side by administrative code supporting user identification, authentication and authorization, and on the response-side by administrative code supporting formatting and rendering of the response for delivery back to the user. Also, after development, the entire application would be limited to use by only that user's client application and type of device.

As a result of this business logic-centric development process, applications tend to be quite limited. For example, as stated above a typical application is developed for use by a single user device/client combination. Also, a desire to add a new business logic element to the application comes with a requirement to also program the administrative request and response functionality along with it. A schematic of this concept is depicted in FIG. 1A. A developer of an application for a User Device/Agent A would have to develop not only the Business Logic element of the application, but also the attendant Client Recognition, Authentication, Authorization, Formatting, UI Generation, Logging and Publishing functionality elements. He would then also be required to develop another complete application based on serving User Device/Agent B. This subsequently forces the development of largely redundant coding for each user type integrated into the development.

Also, since, in prior art development systems the business logic coding is not able to be created independently from its supporting administrative functions, each separate instance of business logic created during application development must include the creation of all of the attendant administrative functionality along with it. Business logic development is thus overly laborious for the developer to create and modify.

### SUMMARY OF THE INVENTION

As a way of overcoming the limitations of the above development scheme, a web application scheme for developing user-independent web applications supporting multiple tool implementations from a single request and response handling framework is disclosed. A tool is a discrete business logic element which interfaces with the request and response framework to produce results of web application requests. The framework concept extends Sun Microsystem's Java Servlet technology to application development by adding abstraction layers on both the request and response sides of the application process flow, thus permitting a single request and response administrative program to be written for a variety of user clients and devices as well as to support multiple business logic tools from the same framework.

Specifically, the system comprises a method for 1) receiving a request from a user, the request arriving in the form of a URL directed at an operative application tool, 2) separating user-specific information from the URL, 3) passing the tool-specific parameters on to the application's business logic tool for action, 4) receiving a result back from the tool, 5) combining (formatting) the result with the user application's environmental information to form a response and 6) returning the formatted response to the user.

A distinguishing feature of the inventive framework is that the request-response layers are independent of business logic tool operators. This is shown schematically in FIGS. 1B and 3. An application developer using the inventive system has only to develop the basic application framework (i.e., the request and response handling administrative process) once and then apply to it any number and variety of business logic tools developed thereafter. The tool developer therefore does not have to concern himself with the administrative functions (e.g., authorization or formatting). He can focus solely on developing the tool.

Another feature of the system is that it is application, client and protocol-independent. As shown in FIG. 1B, the flexible handling framework is designed to be able to receive and process requests from any client device. The request handling layer of the invention produces an abstract version of the client application's request by separating user-specific information (agent used, user's credentials, user's preferences and language, date, time, currency formats, etc.) from the tool-specific parameters of the request, providing the tool operator with a clean, generic request and interfaces for accessing information about the environment (of both the request and the system). The request is then processed by the applicable tool. When the tool has completed it's work on the request, the handling system collects and passes the result of the tool process' response to the response handling layer of the application program. The response handler re-associates the tool-specific portion of the response with the user and web application's particulars, which are stored separately for easy access. The response is reformatted in accordance with the user's agent (web browser, PDA, mobile phone etc.) and presented to the user. A caching system ensures optimal usage of system resources.

The primary benefits of the invention are that it is a more efficient means of developing web-based enterprise applications and for subsequently processing client application requests. By completely separating request dispatching and response presentation logic from tool operation development, software developers concentrate exclusively on business logic and development of specific tools. This helps improve development cycles and the manageability of the development project. It eases the presentation of the web page while allowing flexibility of the look and feel of it.

Also, the system is universal. This invention will work with any web-based client type, for example, web browsers, such as Internet Explorer, and web-enabled mobile phones and PDAs, etc., and can be used to develop any type of multi-user web applications (for example, My Yahoo, Google Mail, etc.). In each case, a business logic tool developed for use by one client type may be utilized by any other type without modification.

### BRIEF DESCRIPTION OF THE DRAWINGS

Exemplary embodiments of the invention are discussed hereinafter in reference to the drawings, in which:

FIG. 1A is a schematic representation of a pair of typical prior art web-based applications, one application serving a User Device A and the other serving a User Device B. Both representations depict the tool-centric nature of prior art applications. All functional (request and response) supporting services must be developed by the application developer along with each business tool created.

FIG. 1B is a schematic representation of the inventive multi-client, multi-tool system indicating that the same application may serve multiple User Device types and that multiple business logic tools may be written so as to utilize a common supporting, administrative request-response framework.

FIG. 2 is a flowchart depicting the distinctly separate request handling, tool operation and response handling functional areas of the inventive system in the processing a user agent's HTTP request.

FIG. 3 is a schematic of the architecture of the application indicating the request-response handling framework supporting multiple business logic tools.

### DETAILED DESCRIPTION OF PREFERRED EXEMPLARY EMBODIMENTS

The request-response handling system of the present invention comprises a web application request and response (R-R) handling framework, serving multiple client types, for which separate business logic “tools” are written as appendages to the R-R framework. Tools are discrete business logic elements which interface with the R-R handling framework to produce results of HTTP requests. The invention comprises both the application concept and the application's method of development.

Both the R-R handling framework and business logic tool functional programs are developed based on the Java programming language. The functional programs are created using libraries of application development code, developed as part of the invention. The concept and rudiments of creating web-based applications from development code libraries is well known by those skilled in the art. However, the development code in the present invention's libraries is generally grouped into two groups: “administrative” request/response handling framework development code—used for developing the request and response framework, and “operative”, business logic tool development code—used for developing the tools.

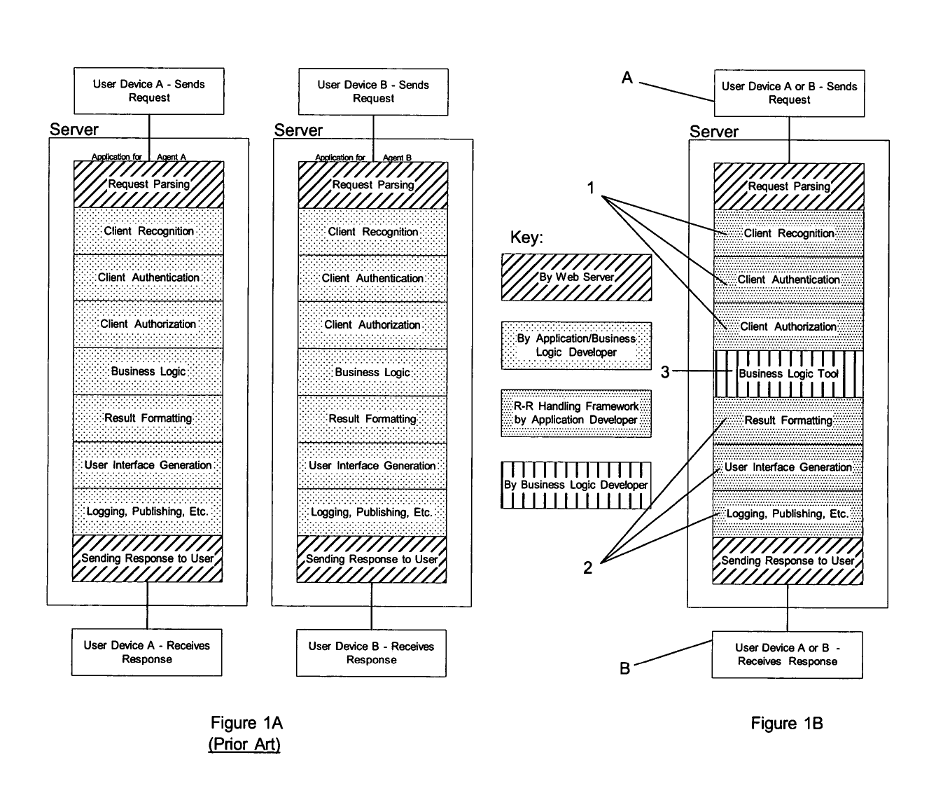

As is shown in FIG. 1B, the application's administrative framework generally comprises a set of request-processing administrative functions 1 including client recognition, client authorization and client authentication as shown, as well as certain other pre-business logic functions as are further described hereunder. The framework also comprises a set of response-processing administrative functions 2 including result formatting, user interface generation, logging and publishing. As a unique feature of the inventive handling system, the service provider's business logic tools 3 are developed separately from the request and response framework components 1 and 2. They are created as an operational appendage to the framework and operate by interfacing with it to perform business logic functions in a focused and efficient manner. Significantly, the business logic tools are developed for use with the administrative framework's processes without the need for making modifications to them in order to append the tools. Thus the service provider's tool developer is not concerned with developing application support functions such as authorizing or formatting along with his tools. He may focus his attention entirely on the business logic aspects of the tool.

In another key aspect of the invention, multiple tools may be developed for the same request and response administrative framework. Each tool is able to interface seamlessly with the common framework, none of the tool additions necessitating modifications to the framework for integration.

Also, as indicated in FIG. 1B, multiple user devices may initiate requests (Box A) and receive respective responses (Box B) from the same application framework. During the development of the application, the developer integrates functionality for multiple user entity (agent) formats, in the form of XSLT stylesheet plugins, the variety of which are based on the variation in the types of user devices and attendant client applications anticipated by the developer.

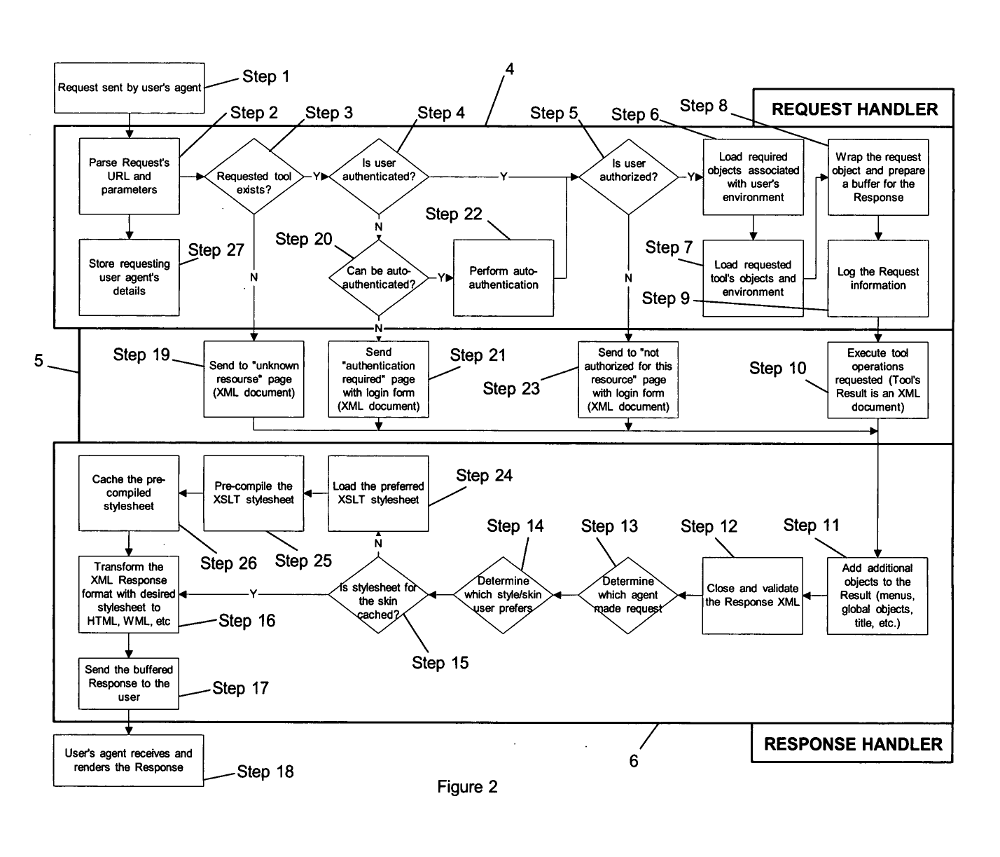

FIG. 2 is a process flow chart depicting the operation of a completely developed application utilizing the request-response framework. In the exemplary embodiment shown, the administrative framework and operative tools function as an integrated application, even though the framework and the tools were written separately. The application functions generally similar to conventional web-based applications. It receives tool service requests from a user's client application, authorizes use of the tool, executes the tool operation, formats the result of the tool operation into a response and formats and transmits the response to the user. Although the general work done by the application is similar to conventional programs, there are significant inventive differences in its method of operation which make the framework adaptable to a wide variety of user types.

First, the application process is roughly divided into three functional areas: the request handling function 4, the tool operation function 5 and the response handling function 6.

The request handling function begins at step 1 within the request handler 4, where a user's client application sends an HTTP request in the form of a URL to the application server. In step 2, the server parses the URL and other parameters, into a structure usable by the application. Next in step 3, the process examines whether or not the requested business logic tool exists. If it does, the process passes to step 4. If not, an “Unknown Resource” error message in the form of an XML document is generated and forwarded as a response for delivery by response handler 6.

In step 4 and step 5, the process examines whether or not the user can be authenticated and is authorized. Steps 20, 21, 22 and 23 deal with options for non-authenticated users, ultimately sending an XML “Authentication Required” error message to the response handler 6, if the user is not able to be auto-authenticated, and for non-authorized users, sending a “Not Authorized to Access this Resource” error message with a login page for delivery by handler 6.

If the user is both authenticated and authorized, the process passes to step 6, where objects associated with the user's environment are loaded from the database, hard drive and server's cache into system memory. Next, in step 7, the objects associated with the requested tool are also loaded into the memory. The objects loaded in steps 6 and 7 are then used to wrap the request object in step 8 in preparation processing by the tool operator. At the same time, a portion of the processing memory is prepared for use as a buffer to receive and temporarily store the tool operation's response to the request.

In step 9, the request is logged before being passed to the tool operation function 5. Within steps 1-9, the application process results in the production of an abstract of the request object for use by the business tools 3 such that the tools have no specific knowledge of the requesting user entity's environment (i.e., which HTML format is required or what type of user device made the request).

The process then passes into the tool operation function 5. In step 10, the business logic is carried out by the requested tool on the wrapped request object. The tool uses a set of display APIs to generate its result. The APIs will process the result and write it, in the form of an XML document to the above-mentioned, pre-prepared response buffer. Thus, the tools instruct the response handler what information to render, but not how to render it. The result, now in XML format, is stored in the buffer as a structured response. The process then proceeds to the response handling functional area 6.

The response handler 6 takes control of either the error messages generated in steps 19, 21 or 23 above or the tool handler's response from step 10. Each type of response in the form of an XML document, which has been temporarily stored in the buffer. In step 11, additional objects (such as menus, global objects, etc.) are added to the response, and in step 12, the transformation is completed with the closing and validation of the XML response.

At this point, the process deviates greatly from most conventional applications. Because the invention accommodates multiple user devices and agents, information related to the requesting user's environment was temporarily stored in memory (step 27). As will be explained below, the response handler retrieves this stored information and then matches the details of the requesting user's environment to presentation formats stored for that environment before formatting and returning the response to the user. The formatting details are provided by integrators in the form of XSLT stylesheet plugins during application development, based on the types of user agents anticipated.

In step 13, the response handler checks the stored user agent information and determines which type of user agent was used for the request. In step 14, the process determines which style or skin the user prefers to use.

In step 15, the handler determines if the stylesheet for the desired skin has been cached. If so, in step 16, the XML response is transformed to the desired format (e.g., HTML, WML, etc.) using the selected stylesheet. If the stylesheet has not been cached, the stylesheet is loaded in step 24, pre-compiled in step 25 and cached in step 26. The process then proceeds to step 16, as above.

Finally, in step 17, the transformed response is sent to the user, where, in step 18, the user's agent receives and renders it on the user's device.

The foregoing depicts an embodiment of a high-level conceptual system for developing web-based applications which support multiple user agent types and multiple business logic tools from a single request-response handling framework. The system is based on the use of the Java programming language in this instance, but it would be understood by those skilled in the art that any other type of language may be utilized in its creation, and that the details of the inner workings of the specific functional processes may be widely varied without departing from the teachings of the inventive concept.

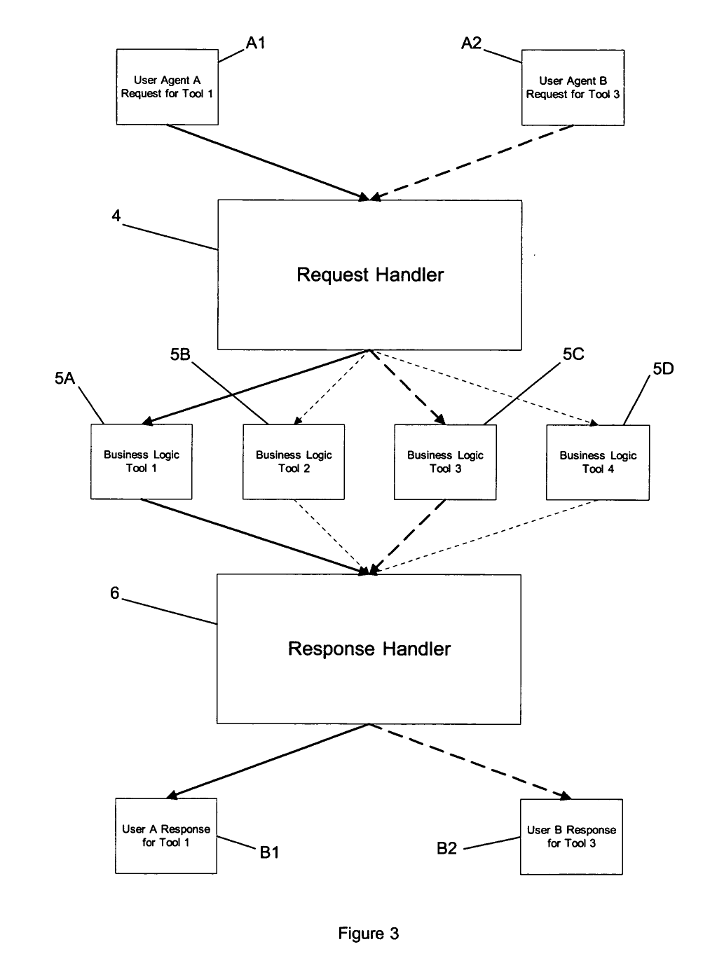

FIG. 3 depicts an architectural view of the application system indicating the request and response framework 4 and 6, interfacing with multiple tools 5A, 5B, 5C and 5D, and supporting multiple user agents' requests A1 and A2. As shown in the figure, user A's agent submits a request (A1) to the application for the business logic of tool 1 (5A). The request is received and processed by request handler 4. Concurrently, user B's agent submits a request (A2) to the application for the business logic of tool 3 (5C).

The request handler services both requests, sending an abstract of each request to the respective tools. The response handler 6 receives the resultant XML document from each tool and formats and delivers the response from tool 1 to user A (B1) and formats the response from tool 3 to user B (B2). Fundamental to the concept of the application and its development is the fact that the same request and response handling framework (4 and 6, respectively) serves both (and all pre-authorized) user types and supports all appended tools.

Because many varying and different embodiments may be made within the scope of the inventive concept herein taught, and because many modifications may be made in the embodiments herein detailed in accordance with the descriptive requirements of the law, it is to be understood that the details herein are to be interpreted as illustrative and not in a limiting sense.

1. An architecture for web-based applications comprising:
a common administrative request and response handling framework, wherein said framework operates by administering requests from and responses to
at least one type of user entity, wherein said administering comprises operatively interfacing with
at least one separately-developed business logic tool operatively appended to said framework to perform business logic as a result of said request.

2. The architecture of claim 1 wherein,
said request comprises an HTTP protocol request from a client application within said user entity to said framework; and wherein,
said response comprises a corresponding HTTP protocol response from said framework to said client application.

3. The architecture of claim 1 wherein said framework comprises an administrative request and response handling algorithm, said algorithm comprising a request side and a response side, wherein said algorithm administers requests from and responses to said at least one type of user entity.

4. The architecture of claim 3 wherein said administering further comprises:
handling a request, comprising the authenticating and authorizing of said user initiating said request;
preparing a wrapped abstract of said request as a wrapped request object for processing by said tool;
said operatively interfacing with said tool to produce a result,
receiving said result from said tool;
preparing said response from said result for delivery to said user entity; and
delivering said response to said user entity in a format usable by said entity.

5. The architecture of claim 4 wherein said preparing comprises formatting said response for display by said user entity.

6. The architecture of claim 1 wherein said user entity comprises a combination of a user device and client application.

7. The architecture of claim 1 wherein said at least one type of user entity comprises multiple, diverse types of user device and client application combinations each accessing said framework concurrently to send said requests and receive said responses in their respective user formats.

8. The architecture of claim 1 wherein said separately-developed comprises creation of said tool independent of functions related to said administering of requests and responses.

9. The architecture of claim 1 wherein said tool comprises a functional program performing a service at the request of said user entity.

10. The architecture of claim 1 wherein said appended comprises operatively integrating said tool into said application without making modifications to said administrative framework.

11. A web-based application process comprising:
administering requests from and responses to at least one type of user entity via a common administrative request and response handling framework, wherein said administering comprises:
operatively interfacing with at least one separately-developed business logic tool operatively appended to said framework.

12. The architecture of claim 11 wherein,
said requests comprise HTTP protocol requests from a client application within said user entity to said framework; and wherein,
said responses comprise corresponding HTTP protocol responses from said framework to said client application.

13. The architecture of claim 11 wherein said framework comprises an administrative request and response handling algorithm, said algorithm comprising a request side and a response side, wherein said algorithm administers requests from and responses to said at least one type of user entity.

14. The architecture of claim 13 wherein said administering further comprises:
handling a request, comprising the authenticating and authorizing of said user initiating said request;
storing user interface details, said interface details indicating formatting requirements for said user entity based upon user entity information received with said request;
preparing a wrapped abstract of said request as a wrapped request object for processing by said tool;
said operatively interfacing with said tool to produce a result,
receiving said result from said tool;
determining response formatting for said response from said interface details;
preparing for delivery to said user entity said response based on said response formatting; and
delivering said response to said user entity.

15. The architecture of claim 14 wherein said preparing comprises formatting said response for display by said user entity based on said response formatting.

16. The architecture of claim 11 wherein said user entity comprises a combination of a user device and client application.

17. The architecture of claim 11 wherein said at least one type of user entity comprises multiple, diverse types of user device and client application combinations each accessing said framework concurrently to send said requests and receive said responses in their respective user formats.

18. The architecture of claim 11 wherein said separately-developed comprises creation of said tool independent of functions related to said administering of requests and responses.

19. The architecture of claim 11 wherein said tool comprises a functional program performing a service at the request of said user entity.

20. The architecture of claim 11 wherein said appended comprises operatively integrating said tool into said application without making modifications to said administrative framework.

21. A web-based application development method comprising:
employing a set of development code libraries, wherein said development code libraries comprise administrative development code and operative development code, in
designing a web-based administrative request and response handling framework, employing said administrative development code, said framework comprising an administrative request and response handling algorithm, said algorithm comprising a request side and a response side, wherein said algorithm administers requests from and responses to at least one type of user entity;
designing at least one business logic tool, employing said operative development code, said tool comprising a business logic operation performed as a result of said request, wherein said tool operatively interfaces with said framework to:
receive an abstracted version of said request from said request side of said algorithm,
perform business logic requested by said abstracted version of said request, and
return a result to said response side of said algorithm; and
operatively appending said tool to said framework.

22. The architecture of claim 21 wherein,
said requests comprise HTTP protocol requests from a client application within said user entity to said framework; and wherein,
said responses comprise corresponding HTTP protocol responses from said framework to said client application.

23. The architecture of claim 21 wherein said user entity comprises a combination of a user device and client application.

24. The architecture of claim 21 wherein said at least one type of user entity comprises multiple, diverse types of user device and client application combinations each accessing said framework concurrently to send said requests and receive said responses in their respective user formats.

25. The architecture of claim 21 wherein said abstracted version comprises an HTTP request object stripped of nonessential user entity information and wrapped in required user environment and tool environment objects to create a wrapped request object for processing by said tool.

26. The architecture of claim 21 wherein said appended comprises operatively integrating said tool into said application without making modifications to said administrative framework.
